(19) United States
(12) Patent Application Publication
(10) Pub. No.: US 2006/0110487 A1
(43) Pub. Date: May 25, 2006

(54) Footwear mold assembly with interchangeable mold wall

(75) Inventors: Michael J. Bergmann, Portland, OR (US); Michael Hui, Lake Oswego, OR (US)

Correspondence Address: BANNER & WITCOFF, LTD., 28 STATE STREET, 28th FLOOR, BOSTON, MA, 02109-9601, US

(73) Assignee: Nike Inc., Beaverton, OR (US)

(21) Appl. No.: 10/996,906

(22) Filed: Nov. 24, 2004

(51) Int. Cl. B29D 31/50

(52) U.S. Cl. 425/119

(57) ABSTRACT

A mold assembly for soles of footwear includes a first portion having first and second recesses, and a second portion having first and second projections. The first projection is received in the first recess to define a first cavity for a first sole and the second projection is received in the second recess to define a second cavity for a second sole when the second portion and first portion are mated together. A first removable insert forms at least a substantial portion of a medial side wall of the first recess and defines an exterior surface of a medial side wall of a first sole formed in the first cavity. A second removable insert forms at least a substantial portion of a medial side wall of the second recess and defines an exterior surface of a medial side wall of a second sole formed in the second cavity.

### FIELD OF THE INVENTION

This invention relates generally to a mold for making soles for articles of footwear, and, in particular, to a mold for making soles for articles of footwear in which the medial sidewalls can be modified.

### BACKGROUND OF THE INVENTION

The sole for an article of footwear often includes a midsole to which an upper is secured, and an outsole, which may include a tread pattern for added traction. Molds for making soles for articles of footwear are well known. Such molds may be formed of a first portion and a second portion that cooperate to define a pair of cavities to simultaneously form left and right soles for footwear. By varying the shape of the mold it is possible to alter the appearance and structure or profile of the soles. This may be done to enhance performance characteristics, provide aesthetic appeal, or a combination of the two.

A prior art mold assembly 110 is shown in FIG. 1, in which the lateral sides of an article of footwear can be modified. Mold assembly 110 includes a first portion 112 and a second portion 114 that cooperate to define cavities into which the material to form a pair of soles for an article of footwear is poured, injected or otherwise inserted. In certain preferred embodiments, the sole may be formed of ethylene vinyl acetate (EVA) or polyurethane, for example, thermoplastic polyurethane (TPU).

First portion 112 includes a first recess 116 and a second recess 118 spaced from first recess 116. In the illustrated embodiment, first recess 116 and second recess 118, which are used to form soles for footwear as described in greater detail below, are oriented such that their lateral sides face one another and their medial sides face one another. Thus, as seen in FIG. 1, first recess 116 is used to form a right sole and second recess 118 is used to form a left sole for an article of footwear.

Second portion 114 has a first projection 120 and a second projection 122. First recess 116 receives first projection 120 when first portion 112 and second portion 114 of mold assembly 110 are placed or mated together, defining a first cavity 115 into which material is poured, injected or otherwise deposited into mold assembly 110 to form a left sole of an article of footwear. Second recess 118 receives second projection 122 to define a second cavity 117 into which material is poured, injected or otherwise deposited into mold assembly 110 to form a right sole of the article of footwear.

In the illustrated embodiment, a first groove 124 is formed in first portion 112. First groove 124 is substantially Y-shaped, with a base of the Y shape in communication with an exterior of first portion 112 at a first end thereof. An end of a first arm 126 of the Y shape is in communication with first recess 116 and an end of a second arm 128 of the Y shape is in communication with second recess 118 at a first end thereof. A second groove 130 extends through first portion 112 between a second end of first recess 116 and a second end of second recess 118.

A first groove 132 is formed in second portion 114. First groove 132 is substantially Y-shaped, with a base of the Y shape in communication with an exterior of second portion 114 at a first end thereof. An end of a first arm 134 of the Y shape extends to first projection 120 and an end of a second arm 136 of the Y shape extends to second projection 122 at a first end thereof. A second groove 138 extends through second portion 114 between a second end of first projection 120 and a second end of second projection 122.

When first portion 112 and second portion 114 are mated together to form mold assembly 110, first groove 124 and first groove 132 cooperate and mate with one another to define a channel in fluid communication with an exterior of mold assembly 110 and cavities 115, 117. The material used to form the sole is poured, injected or otherwise inserted through the channel defined by first groove 124 and first groove 132 into cavities 115, 117. Similarly second groove 130 and second groove 138 cooperate and mate with one another to form a channel through which the material can flow, thereby ensuring that the cavities 115, 117 for each of the soles are equally filled with material.

In the illustrated embodiment, a medial side wall 140 of first recess 116 and a medial side 142 wall of second recess 118 are each positioned adjacent an exterior of first portion 112. Consequently, a lateral side wall 144 of first recess 116 is adjacent a lateral side wall 146 of second recess 118.

Similarly, a medial side wall 148 of first projection 120 and a medial side wall 150 of second projection 122 are each adjacent an exterior of second portion 114. Consequently, a lateral side wall 152 of first projection 120 is adjacent a lateral side wall 154 of second projection 122.

When mold assembly 110 is used to form a pair of soles, the exterior profile of the side walls of the soles are defined by the corresponding profile of the side wall of first portion 112. Thus, any surface irregularities such as projections or ribs 156 and grooves 158, for example, formed in lateral side walls 144, 146 and medial side walls 140, 142 result in corresponding grooves and ribs, respectively, in the lateral side walls and medial side walls of the soles formed by mold assembly 110.

First portion 112 includes a removable insert 186, which forms at least a substantial portion of lateral side wall 144 of first recess 116 and at least a substantial portion of lateral side wall 146 of second recess 118. Thus, the ribs 156 and grooves 158 formed in removable insert 186 form corresponding grooves and ribs on the lateral side walls of the soles formed by mold assembly 110.

Base 164 of first recess 116 and a base of second recess 118 may also include surface irregularities such as ribs 166, projections 168 and a raised portion 170 in a heel area 172. These surface irregularities form corresponding grooves and recesses in the interior surface of the soles formed by mold assembly 110. The raised portions 170 are shaped to produce recesses that are sized and shaped to receive bladders in the heel portions of the soles.

First projection 120 and second projection 122 may also include surface irregularities such as ribs 174, raised portions 176 and grooves 178, which form corresponding grooves, recesses and projections, respectively, on the exterior surface of the soles formed by mold assembly 110.

It is an object of the present invention to provide a mold assembly for making soles for articles of footwear that reduces or overcomes some or all of the difficulties inherent in prior known devices. Particular objects and advantages of the invention will be apparent to those skilled in the art, that is, those who are knowledgeable or experienced in this field of technology, in view of the following disclosure of the invention and detailed description of certain preferred embodiments.

### SUMMARY

The principles of the invention may be used to advantage to provide a mold for making soles of articles of footwear that may have different patterns on their medial and/or lateral sidewalls. In accordance with a first aspect, a mold assembly for soles of an article of footwear includes a first portion having a first recess and a second recess, and a second portion having a first projection and a second projection. The first projection is received in the first recess to define a first cavity for a first sole and the second projection is received in the second recess to define a second cavity for a second sole when the second portion and first portion are mated together. A first removable insert forms at least a substantial portion of a medial side wall of the first recess and defines an exterior surface of a medial side wall of a first sole formed in the first cavity. A second removable insert forms at least a substantial portion of a medial side wall of the second recess and defines an exterior surface of a medial side wall of a second sole formed in the second cavity.

In accordance with another aspect, a mold assembly for soles of an article of footwear includes a first portion having a first recess and a second recess, and a second portion having a first projection and a second projection. The first projection is received in the first recess to define a first cavity for a first sole, and the second projection is received in the second recess to define a second cavity for a second sole when the second portion and first portion are mated together. A first removable insert forms at least a substantial portion of a medial side wall of the first recess and has a surface irregularity to form a pattern on a medial side wall of a sole formed in the first cavity. A second removable insert forms at least a substantial portion of a medial side wall of the second recess and has a surface irregularity to form a pattern on a medial side wall of a sole formed in the second cavity. A first groove is formed in the first portion and is in fluid communication with an exterior of the first portion and the first and second recesses. A second groove is formed in the second portion and is in fluid communication with an exterior of the second portion and the first and second projections. The first groove and the second groove cooperate to define a channel in fluid communication with an exterior of the first and second portions and the first and second cavities.

In accordance with a further aspect, a mold assembly for soles of an article of footwear includes a first portion having a first recess and a second recess, and a second portion having a first projection and a second projection. The first projection is received in the first recess to define a first cavity for a first sole, and the second projection is received in the second recess to define a second cavity for a second sole when the second portion and first portion are mated together. A removable insert forms at least a substantial portion of a medial side wall of the first recess and at least a substantial portion of a medial side wall of the second recess.

In accordance with yet another aspect, a mold assembly for soles of an article of footwear includes a first portion having a first recess and a second recess, and a second portion having a first projection and a second projection. The first projection is received in the first recess to define a first cavity for a first sole, and the second projection is received in the second recess to define a second cavity for a second sole when the second portion and first portion are mated together. A removable insert forms at least a substantial portion of a medial side wall of the first recess and at least a substantial portion of a medial side wall of the second recess, and has surface irregularities to form a pattern on medial side walls of soles formed in the first and second cavities. A first groove is formed in the first portion and is in fluid communication with an exterior of the first portion and the first and second recesses. A second groove is formed in the second portion and is in fluid communication with an exterior of the second portion and the first and second projections. The first groove and the second groove cooperate to define a channel in fluid communication with an exterior of the first and second portions and the first and second cavities.

In accordance with yet a further aspect, a mold assembly for soles of an article of footwear includes a first portion having a first recess and a second recess, and a second portion having a first projection and a second projection. The first projection is received in the first recess to define a first cavity for a first sole, and the second projection is received in the second recess to define a second cavity for a second sole when the second portion and first portion are mated together. A first removable insert forms at least a substantial portion of a medial side wall of the first recess and at least a substantial portion of a medial side wall of the second recess, and has surface irregularities to form a pattern on medial side walls of soles formed in the first and second cavities. A second removable insert forms at least a substantial portion of a lateral side wall of the first recess and defines an exterior surface of a lateral side wall of a first sole formed in the first cavity. A third removable insert forms at least a substantial portion of a lateral side wall of the second recess and defines an exterior surface of a lateral side wall of the second sole formed in the second cavity. A first groove is formed in the first portion and is in fluid communication with an exterior of the first portion and the first and second recesses. A second groove is formed in the second portion and is in fluid communication with an exterior of the second portion and the first and second projections. The first groove and the second groove cooperate to define a channel in fluid communication with an exterior of the first and second portions and the first and second cavities.

In accordance with an additional aspect, a mold assembly for soles of an article of footwear includes a first portion having a first recess and a second recess. A second portion has a first projection and a second projection, with the first projection received in the first recess to define a first cavity for a first sole and the second projection received in the second recess to define a second cavity for a second sole when the second portion and first portion are mated together. A first removable insert forms at least a substantial portion of a lateral side wall of the first recess and defines an exterior surface of a lateral side wall of a first sole formed in the first cavity. A second removable insert forms at least a substantial portion of a lateral side wall of the second recess and defines an exterior surface of a lateral side wall of a second sole formed in the second cavity.

In accordance with another aspect, a mold assembly for soles of an article of footwear includes a first portion having a first recess and a second recess. A second portion has a first projection and a second projection, with the first projection received in the first recess to define a first cavity for a first sole and the second projection received in the second recess to define a second cavity for a second sole when the second portion and first portion are mated together. A first insert forms at least a substantial portion of a lateral side wall of the first recess and at least a substantial portion of a lateral side wall of the second recess. A second removable insert forms at least a substantial portion of a medial side wall of the first recess and defines an exterior surface of a medial side wall of a first sole formed in the first cavity. A third removable insert forms at least a substantial portion of a medial side wall of the second recess and defines an exterior surface of a medial side wall of a second sole formed in the second cavity.

Substantial advantage is achieved by providing a mold for making soles for articles of footwear in accordance with the present invention. In particular, certain preferred embodiments allow molding of one or more sets of soles with a first profile or pattern on their medial sides and subsequently molding one or more sets of soles with a second profile or pattern on their medial sides. This is highly advantageous since it can reduce the setup time and manufacturing costs for producing various types of soles.

These and additional features and advantages of the invention disclosed here will be further understood from the following detailed disclosure of certain preferred embodiments.

### BRIEF DESCRIPTION OF THE DRAWINGS

FIG. 1 is a perspective view of a mold assembly of the prior art, showing first and second portions of the mold.

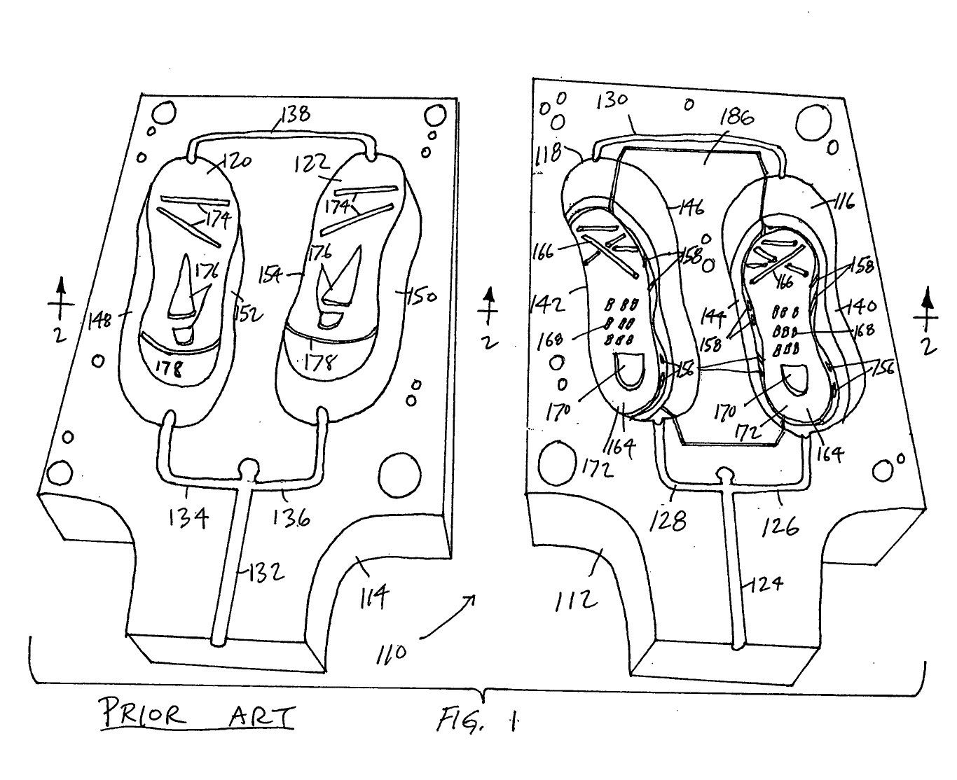

FIG. 2 is a section view, taken along line 2-2 of FIG. 1, showing the mold assembly of FIG. 1 in an assembled condition.

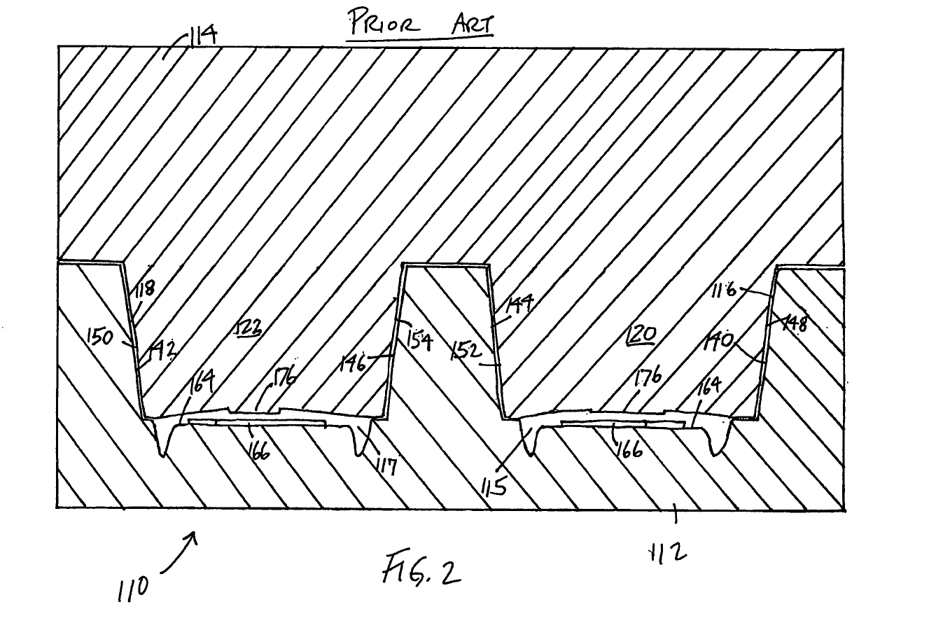

FIG. 3 is a perspective view of a mold assembly in accordance with a preferred embodiment of the present invention, showing first and second portions of the mold.

FIG. 4 is a section view, taken along line 4-4 of FIG. 3, showing the mold assembly of FIG. 3 in an assembled condition.

FIG. 5 is a perspective view of a mold assembly in accordance with another preferred embodiment of the present invention, showing first and second portions of the mold.

FIG. 6 is a perspective view of a mold assembly in accordance with yet another preferred embodiment of the present invention, showing first and second portions of the mold.

FIG. 7 is a plan view of a mold assembly in accordance with another preferred embodiment of the present invention, showing a first portion, which includes a bottom plate and a sidewall plate, and a second portion of the mold.

The figures referred to above are not drawn necessarily to scale and should be understood to provide a representation of the invention, illustrative of the principles involved. Some features of the mold for making soles for articles of footwear depicted in the drawings have been enlarged or distorted relative to others to facilitate explanation and understanding. The same reference numbers are used in the drawings for similar or identical components and features shown in various alternative embodiments. Molds for making soles for articles of footwear as disclosed herein would have configurations and components determined, in part, by the intended application and environment in which they are used.

### DETAILED DESCRIPTION OF CERTAIN PREFERRED EMBODIMENTS

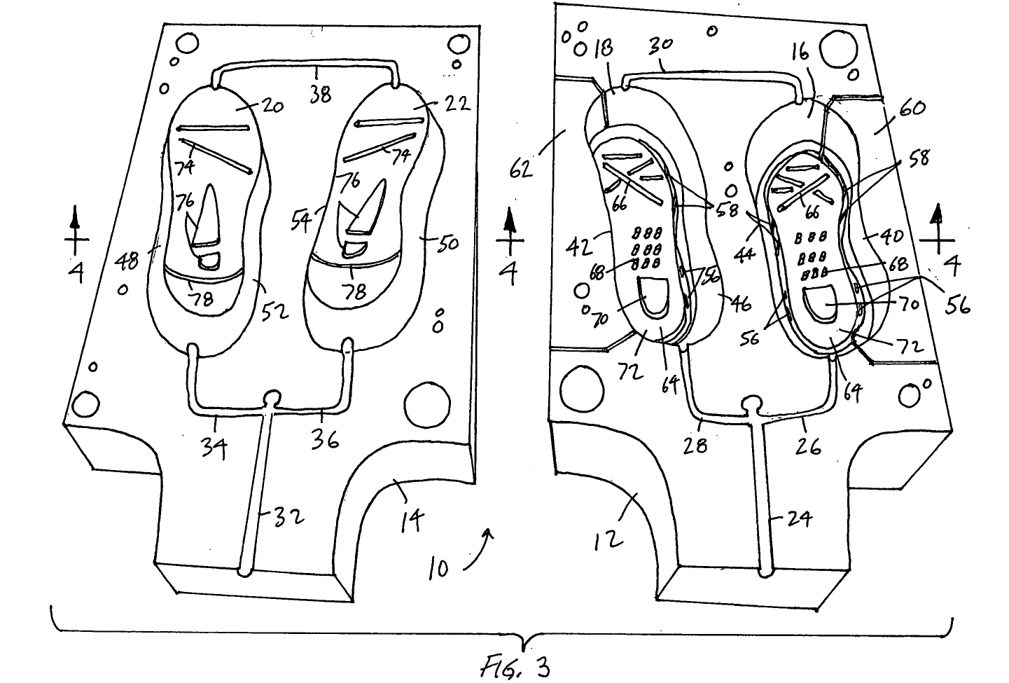

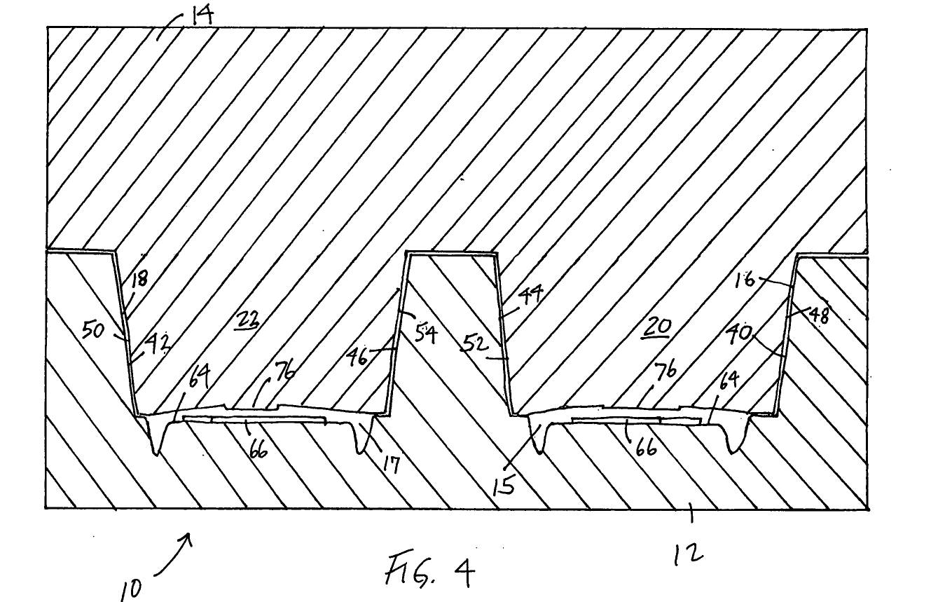

The present invention may be embodied in various forms. A preferred embodiment of a mold assembly 10 is shown in FIGS. 3-4. Mold assembly 10 is typically used to form a midsole for an article of footwear, with an outsole being formed separately and secured to the midsole by adhesive or other suitable means. In certain embodiments, a sole formed by mold assembly 10 may comprise the entire sole assembly, with a tread pattern being formed on the lower surface of the sole in mold assembly 10 to provide traction for the article of footwear.

Mold assembly 10 includes a first portion 12 and a second portion 14 that cooperate to define cavities into which the material to form a pair of soles for an article of footwear is poured, injected or otherwise inserted. In certain preferred embodiments, the sole may be formed of ethylene vinyl acetate (EVA) or polyurethane, for example, thermoplastic polyurethane (TPU).

First portion 12 includes a first recess 16 and a second recess 18 spaced from first recess 16. In the illustrated embodiment, first recess 16 and second recess 18, which are used to form soles for footwear as described in greater detail below, are oriented such that their medial sides face outwardly and their lateral sides face one another. Thus, as seen in FIG. 3, first recess 16 is used to form a left sole and second recess 18 is used to form a right sole for an article of footwear.

Second portion 14 has a first projection 20 and a second projection 22. First recess 16 receives first projection 20 when first portion 12 and second portion 14 of mold assembly 10 are placed or mated together, defining a first cavity 15 into which material is poured, injected or otherwise deposited into mold assembly 10 to form a left sole of an article of footwear. Second recess 18 receives second projection 22 to define a second cavity 17 into which material is poured, injected or otherwise deposited into mold assembly 10 to form a right sole of the article of footwear.

In the illustrated embodiment, a first groove 24 is formed in first portion 12. First groove 24 is substantially Y-shaped, with a base of the Y shape in communication with an exterior of first portion 12 at a first end thereof. An end of a first arm 26 of the Y shape is in communication with first recess 16 and an end of a second arm 28 of the Y shape is in communication with second recess 18 at a first end thereof. A second groove 30 extends through first portion 12 between a second end of first recess 16 and a second end of second recess 18.

A first groove 32 is formed in second portion 14. First groove 32 is substantially Y-shaped, with a base of the Y shape in communication with an exterior of second portion 14 at a first end thereof. An end of a first arm 34 of the Y shape extends to first projection 20 and an end of a second arm 36 of the Y shape extends to second projection 22 at a first end thereof. A second groove 38 extends through second portion 14 between a second end of first projection 20 and a second end of second projection 22.

When first portion 12 and second portion 14 are mated together to form mold assembly 10, first groove 24 and first groove 32 cooperate and mate with one another to define a channel in fluid communication with an exterior of mold assembly 10 and cavities 15, 17. The material used to form the sole is poured, injected or otherwise inserted through the channel defined by first groove 24 and first groove 32 into cavities 15, 17. Similarly second groove 30 and second groove 38 cooperate and mate with one another to form a channel through which the material can flow, thereby ensuring that the cavities 15, 17 for each of the soles are equally filled with material.

In the illustrated embodiment, a medial side wall 40 of first recess 16 and a medial side 42 wall of second recess 18 are each positioned adjacent an exterior of first portion 12. Consequently, a lateral side wall 44 of first recess 16 is adjacent a lateral side wall 46 of second recess 18.

Similarly, a medial side wall 48 of first projection 20 and a medial side wall 50 of second projection 22 are each adjacent an exterior of second portion 14. Consequently, a lateral side wall 52 of first projection 20 is adjacent a lateral side wall 54 of second projection 22.

When mold assembly 10 is used to form a pair of soles, the exterior profile of the side walls of the soles are defined by the corresponding profile of the side wall of first portion 12. Thus, any surface irregularities such as projections or ribs 56 and grooves 58, for example, formed in lateral side walls 44, 46 and medial side walls 40, 42 result in corresponding grooves and ribs, respectively, in the lateral side walls and medial side walls of the soles formed by mold assembly 10.

First portion 12 includes a first removable insert 60 and a second removable insert 62. First removable insert 60 forms at least a substantial portion of medial side wall 40 of first recess 16 while second removable insert 62 forms at least a substantial portion of medial side wall 42 of second recess 18. Thus, the ribs 56 and grooves 58 formed in first and second removable inserts 60, 62 form corresponding grooves and ribs on the medial side walls of the soles formed by mold assembly 10.

The ability to change first and second removable inserts 60, 62 provides the ability to create soles having different medial side wall profiles and the same lateral side walls. This can be done simply by replacing removable inserts 60, 62 with removable inserts having a different profile rather than requiring an entirely different mold. It is to be appreciated that one or both of removable inserts 60, 62 could be replaced to produce pairs of soles having identical lateral side walls but varied medial side walls. By producing a plurality of additional removable inserts, a large number of soles can be produced having different sole profiles. This allows for quick changeover between manufacturing runs and reduces the time, labor and costs associated with manufacturing soles for footwear having different profiles.

In certain preferred embodiments, a base 64 of first recess 16 and a base of second recess 18 may also include surface irregularities such as ribs 66, projections 68 and a raised portion 70 in a heel area 72. These surface irregularities form corresponding grooves and recesses in the interior surface of the soles formed by mold assembly 10. The raised portions 70 are shaped to produce recesses that are sized and shaped to receive bladders in the heel portions of the soles.

First projection 20 and second projection 22 may also include surface irregularities such as ribs 74, raised portions 76 and grooves 78, which form corresponding grooves, recesses and projections, respectively, on the exterior surface of the soles formed by mold assembly 10 that increase traction and grip of the soles.

It is to be appreciated that in another embodiment, first recess 16 and second recess 18 could swap positions such that first removable insert 60 forms lateral side wall 46 of second recess 18, and second removable insert 62 forms lateral side wall 44 of first recess 16. First projection 20 and second projection 22 of second portion 14 would necessarily swap positions as well in such an embodiment. This embodiment would provide the ability to change the profile of the lateral sides of the soles of an article of footwear by using first and second removable inserts 60, 62 with different profiles.

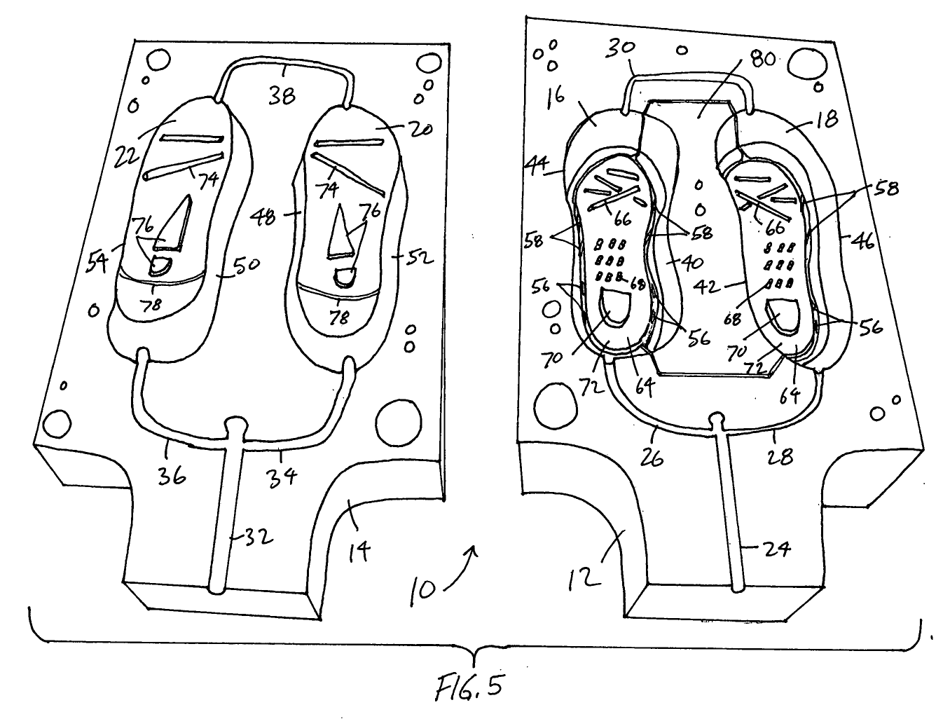

Another preferred embodiment is shown in FIG. 5, in which first recess 16 and second recess 18 are positioned in first portion 12 such that medial side wall 40 of first recess 16 faces medial side wall 42 of second recess 18. In this embodiment, a removable insert 80 is positioned in a central area of first portion 12 such that it forms at least a substantial portion of medial side wall 40 of first recess 16 and medial side wall 42 of second recess 18. Consequently, when removable insert 80 is replaced with another removable insert having a different profile, the medial side walls of the pair of soles that are formed have a different profile than those formed by the removed insert, while the profile of the lateral side walls remains the same.

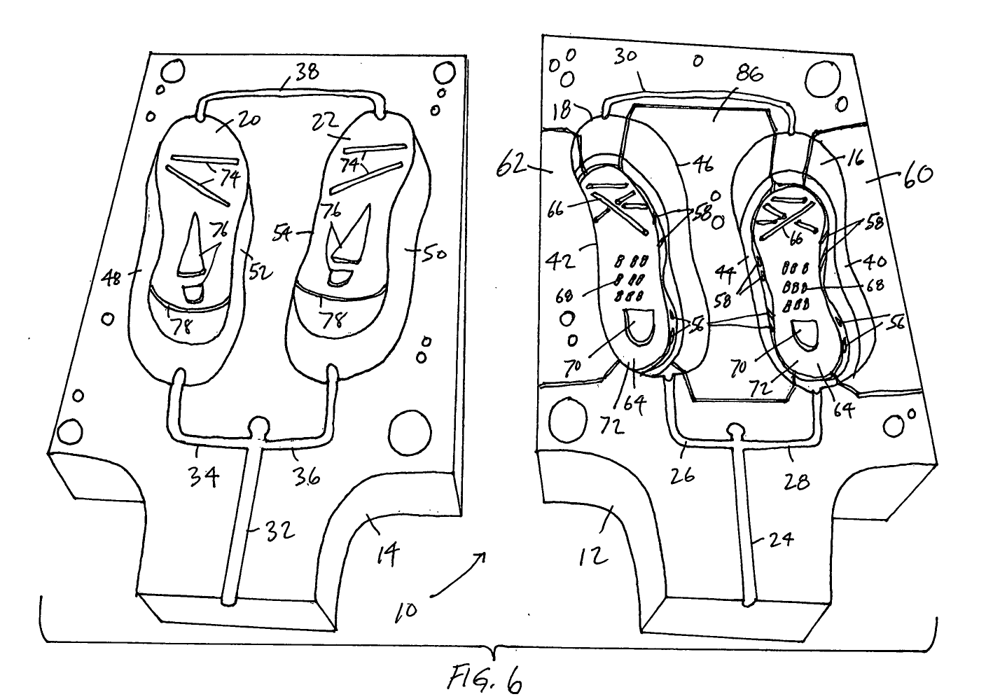

Another preferred embodiment is shown in FIG. 6, which is similar to the embodiment of FIG. 3, in that lateral side wall 44 of first recess 16 faces lateral side wall 46 of second recess 16. In this embodiment, in addition to first removable insert 60 and second removable insert 62 (which form the alterable medial side walls 40, 42 of first and second recesses 16, 18, respectively), a third removable insert 86 is positioned in a central area of first portion 12 such that it forms at least a substantial portion of lateral side wall 44 of first recess 16 and lateral side wall 46 of second recess 18. Consequently, both the medial side walls 40, 42 and lateral side walls 44, 46 can be modified in this embodiment. It is to be appreciated that a similar construction can be used in the embodiment shown in FIG. 5. That is, a second removable insert could be provided to form an alterable lateral side wall 44 of first recess 16 and a third removable insert could be provided to form an alterable lateral side wall 46 of second recess 18.

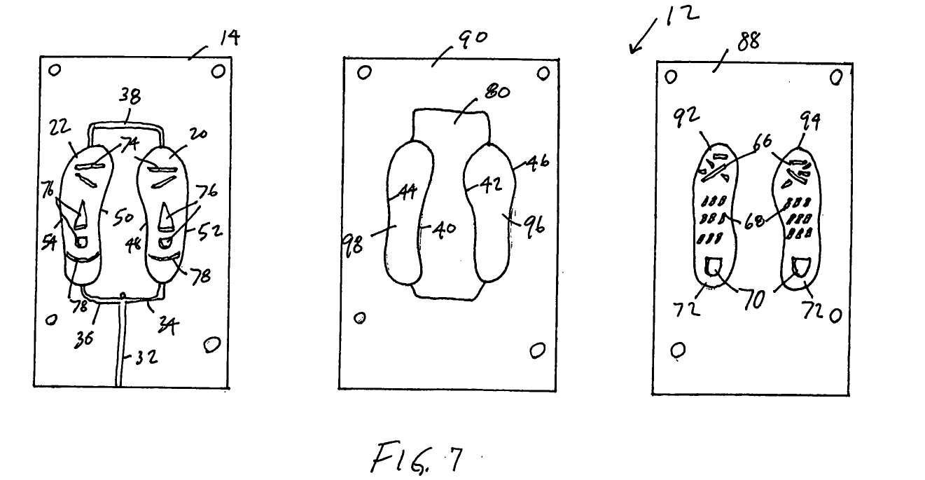

Another embodiment is shown in FIG. 7, in which first portion 12 is formed of a bottom plate 88 and a sidewall plate 90 positioned on bottom plate 88. Bottom plate 88 has a pair of shallow recesses 92, 94 that serve to form the bottom surface of the soles. Sidewall plate 90 has a pair of apertures 96, 98 extending therethrough, which serve to form the sidewalls of the soles and receive projections 22, 20, respectively. Removable insert 86 is formed as a portion of sidewall plate 90.

In light of the foregoing disclosure of the invention and description of the preferred embodiments, those skilled in this area of technology will readily understand that various modifications and adaptations can be made without departing from the scope and spirit of the invention. All such modifications and adaptations are intended to be covered by the following claims.

What is claimed is:

1. A mold assembly for soles of an article of footwear comprising, in combination:
a first portion having a first recess and a second recess;
a second portion having a first projection and a second projection, the first projection received in the first recess to define a first cavity for a first sole and the second projection received in the second recess to define a second cavity for a second sole when the second portion and first portion are mated together; and
a first removable insert forming at least a substantial portion of a medial side wall of the first recess and defining an exterior surface of a medial side wall of a first sole formed in the first cavity; and
a second removable insert forming at least a substantial portion of a medial side wall of the second recess and defining an exterior surface of a medial side wall of a second sole formed in the second cavity.

2. The mold assembly of claim 1, wherein the first removable insert has a surface irregularity to form a pattern on an exterior of a sole formed in the first cavity.

3. The mold assembly of claim 2, wherein the surface irregularity comprises a rib.

4. The mold assembly of claim 2, wherein the surface irregularity comprises a groove.

5. The mold assembly of claim 1, wherein the second removable insert has a surface irregularity to form a pattern on an exterior of a sole formed in the second cavity.

6. The mold assembly of claim 5, wherein the surface irregularity comprises a rib.

7. The mold assembly of claim 5, wherein the surface irregularity comprises a groove.

8. The mold assembly of claim 1, further comprising a first groove formed in the first portion and in fluid communication with an exterior of the first portion and the first and second recesses.

9. The mold assembly of claim 1, further comprising a second groove formed in the second portion and in fluid communication with an exterior of the second portion and the first and second projections, wherein the first groove and the second groove cooperate to define a channel in fluid communication with an exterior of the first and second portions and the first and second cavities.

10. The mold assembly of claim 1, wherein a base surface of each of the first and second recesses includes a surface irregularity.

11. The mold assembly of claim 10, wherein the surface irregularities comprise a rib.

12. The mold assembly of claim 10, wherein the surface irregularities comprise a groove.

13. The mold assembly of claim 10, wherein the surface irregularities comprise a raised portion.

14. The mold assembly of claim 1, further comprising a plurality of additional removable inserts, each additional removable insert configured to form a side wall a sole that has a different pattern than a pattern formed on a side wall of a sole formed by at least one of the other removable inserts.

15. The mold assembly of claim 1, further comprising an additional removable insert forming at least a substantial portion of a lateral side wall of the first recess and a lateral side wall of the second recess and defining exterior surfaces of lateral side walls of the first and second soles formed in the first and second cavities, respectively.

16. A mold assembly for soles of an article of footwear comprising, in combination:
a first portion having a first recess and a second recess;
a second portion having a first projection and a second projection, the first projection received in the first recess to define a first cavity for a first sole and the second projection received in the second recess to define a second cavity for a second sole when the second portion and first portion are mated together; and
a first removable insert forming at least a substantial portion of a medial side wall of the first recess and having a surface irregularity to form a pattern on a medial side wall of a sole formed in the first cavity; and
a second removable insert forming at least a substantial portion of a medial side wall of the second recess and having a surface irregularity to form a pattern on a medial side wall of a sole formed in the second cavity;
a first groove formed in the first portion and in fluid communication with an exterior of the first portion and the first and second recesses;
a second groove formed in the second portion and in fluid communication with an exterior of the second portion and the first and second projections, wherein the first groove and the second groove cooperate to define a channel in fluid communication with an exterior of the first and second portions and the first and second cavities.

17. The mold assembly of claim 16, further comprising a plurality of additional removable inserts, each additional removable insert configured to form a medial side wall a sole that has a different pattern than a pattern formed on a medial side wall of a sole formed by at least one of the other removable inserts.

18. The mold assembly of claim 16, further comprising an additional removable insert forming at least a substantial portion of a lateral side wall of the first recess and a lateral side wall of the second recess and defining exterior surfaces of lateral side walls of the first and second soles formed in the first and second cavities, respectively.

19. A mold assembly for soles of an article of footwear comprising, in combination:
a first portion having a first recess and a second recess;
a second portion having a first projection and a second projection, the first projection received in the first recess to define a first cavity for a first sole and the second projection received in the second recess to define a second cavity for a second sole when the second portion and first portion are mated together; and
a removable insert forming at least a substantial portion of a medial side wall of the first recess and at least a substantial portion of a medial side wall of the second recess.

20. The mold assembly of claim 19, wherein the removable insert has surface irregularities to form a pattern on side walls of soles formed in the first and second cavities.

21. The mold assembly of claim 20, wherein the surface irregularities comprise a rib.

22. The mold assembly of claim 20, wherein the surface irregularities comprise a groove.

23. The mold assembly of claim 19, further comprising a first groove formed in the first portion and in fluid communication with an exterior of the first portion and the first and second recesses.

24. The mold assembly of claim 19, further comprising a second groove formed in the second portion and in fluid communication with an exterior of the second portion and the first and second projections, wherein the first groove and the second groove cooperate to define a channel in fluid communication with an exterior of the first and second portions and the first and second cavities.

25. The mold assembly of claim 19, wherein a base surface of each of the first and second recesses includes a surface irregularity.

26. The mold assembly of claim 25, wherein the surface irregularity comprises a rib.

27. The mold assembly of claim 25, wherein the surface irregularity comprises a groove.

28. The mold assembly of claim 25, wherein the surface irregularity comprises a raised portion.

29. The mold assembly of claim 19, further comprising a plurality of additional removable inserts, each additional removable insert configured to form medial side walls of soles that have a different pattern than a pattern formed on medial side walls of soles formed by at least one of the other removable inserts.

30. The mold assembly of claim 19, further comprising:
a first additional removable insert forming at least a substantial portion of a lateral side wall of the first recess and defining an exterior surface of a lateral side wall of a first sole formed in the first cavity; and
a second removable insert forming at least a substantial portion of a lateral side wall of the second recess and defining an exterior surface of a lateral side wall of a second sole formed in the second cavity.

31. A mold assembly for soles of an article of footwear comprising, in combination:
a first portion having a first recess and a second recess;
a second portion having a first projection and a second projection, the first projection received in the first recess to define a first cavity for a first sole and the second projection received in the second recess to define a second cavity for a second sole when the second portion and first portion are mated together; and
a removable insert forming at least a substantial portion of a medial side wall of the first recess and at least a substantial portion of a medial side wall of the second recess and having surface irregularities to form a pattern on medial side walls of soles formed in the first and second cavities;
a first groove formed in the first portion and in fluid communication with an exterior of the first portion and the first and second recesses;
a second groove formed in the second portion and in fluid communication with an exterior of the second portion and the first and second projections, wherein the first groove and the second groove cooperate to define a channel in fluid communication with an exterior of the first and second portions and the first and second cavities.

32. The mold assembly of claim 31, further comprising a plurality of additional removable inserts, each additional removable insert configured to form medial side walls of soles that have a different pattern than a pattern formed on medial side walls of soles formed by at least one of the other removable inserts.

33. A mold assembly for soles of an article of footwear comprising, in combination:
a first portion having a first recess and a second recess;
a second portion having a first projection and a second projection, the first projection received in the first recess to define a first cavity for a first sole and the second projection received in the second recess to define a second cavity for a second sole when the second portion and first portion are mated together; and
a first removable insert forming at least a substantial portion of a medial side wall of the first recess and at least a substantial portion of a medial side wall of the second recess and having surface irregularities to form a pattern on medial side walls of soles formed in the first and second cavities;
a second removable insert forming at least a substantial portion of a lateral side wall of the first recess and defining an exterior surface of a lateral side wall of a first sole formed in the first cavity;
a third removable insert forming at least a substantial portion of a lateral side wall of the second recess and defining an exterior surface of a lateral side wall of the second sole formed in the second cavity;
a first groove formed in the first portion and in fluid communication with an exterior of the first portion and the first and second recesses; and
a second groove formed in the second portion and in fluid communication with an exterior of the second portion and the first and second projections, wherein the first groove and the second groove cooperate to define a channel in fluid communication with an exterior of the first and second portions and the first and second cavities.

34. A mold assembly for soles of an article of footwear comprising, in combination:
a first portion having a first recess and a second recess;
a second portion having a first projection and a second projection, the first projection received in the first recess to define a first cavity for a first sole and the second projection received in the second recess to define a second cavity for a second sole when the second portion and first portion are mated together; and
a first removable insert forming at least a substantial portion of a lateral side wall of the first recess and defining an exterior surface of a lateral side wall of a first sole formed in the first cavity; and a second removable insert forming at least a substantial portion of a lateral side wall of the second recess and defining an exterior surface of a lateral side wall of a second sole formed in the second cavity.

35. The mold assembly of claim 34, wherein the first removable insert has a surface irregularity to form a pattern on an exterior of a sole formed in the first cavity.

36. The mold assembly of claim 35, wherein the surface irregularity comprises a rib.

37. The mold assembly of claim 35, wherein the surface irregularity comprises a groove.

38. The mold assembly of claim 34, wherein the second removable insert has a surface irregularity to form a pattern on an exterior of a sole formed in the second cavity.

39. The mold assembly of claim 38, wherein the surface irregularity comprises a rib.

40. The mold assembly of claim 38, wherein the surface irregularity comprises a groove.

41. The mold assembly of claim 34, further comprising a first groove formed in the first portion and in fluid communication with an exterior of the first portion and the first and second recesses.

42. The mold assembly of claim 34, further comprising a second groove formed in the second portion and in fluid communication with an exterior of the second portion and the first and second projections, wherein the first groove and the second groove cooperate to define a channel in fluid communication with an exterior of the first and second portions and the first and second cavities.

43. The mold assembly of claim 34, wherein a base surface of each of the first and second recesses includes a surface irregularity.

44. The mold assembly of claim 43, wherein the surface irregularities comprise a rib.

45. The mold assembly of claim 43, wherein the surface irregularities comprise a groove.

46. The mold assembly of claim 43, wherein the surface irregularities comprise a raised portion.

47. The mold assembly of claim 34, further comprising a plurality of additional removable inserts, each additional removable insert configured to form a side wall a sole that has a different pattern than a pattern formed on a side wall of a sole formed by at least one of the other removable inserts.

48. The mold assembly of claim 34, further comprising an additional removable insert forming at least a substantial portion of a lateral side wall of the first recess and a lateral side wall of the second recess and defining exterior surfaces of lateral side walls of the first and second soles formed in the first and second cavities, respectively.

49. A mold assembly for soles of an article of footwear comprising, in combination:
a first portion having a first recess and a second recess;
a second portion having a first projection and a second projection, the first projection received in the first recess to define a first cavity for a first sole and the second projection received in the second recess to define a second cavity for a second sole when the second portion and first portion are mated together; and
a first insert forming at least a substantial portion of a lateral side wall of the first recess and at least a substantial portion of a lateral side wall of the second recess;
a second removable insert forming at least a substantial portion of a medial side wall of the first recess and defining an exterior surface of a medial side wall of a first sole formed in the first cavity; and
a third removable insert forming at least a substantial portion of a medial side wall of the second recess and defining an exterior surface of a medial side wall of a second sole formed in the second cavity.
